(19) United States
(12) Patent Application Publication
(10) Pub. No.: US 2023/0094253 A1
(43) Pub. Date: Mar. 30, 2023

(54) SEAT GUIDANCE DEVICE, SYSTEM, METHOD, AND NON-TRANSITORY COMPUTER-READABLE MEDIUM HAVING PROGRAM STORED THEREON

(71) Applicant: NEC Corporation, Minato-ku, Tokyo (JP)

(72) Inventor: Hiroshi Suzuki, Tokyo (JP)

(73) Assignee: NEC Corporation, Minato-ku, Tokyo (JP)

(21) Appl. No.: 17/911,462

(22) PCT Filed: Mar. 30, 2020
(86) PCT No.: PCT/JP2020/014613

§ 371 Date: Sep. 14, 2022

(51) Int. Cl. G01C 21/20; G06Q 10/02; G06F 21/32; G06V 40/16

(52) U.S. Cl. CPC G01C 21/206; G06Q 10/02; G06F 21/32; G06V 40/172

(57) ABSTRACT

A seat guidance device includes: an authentication control unit that causes an authentication device storing registered face feature information of a plurality of visitors to perform face authentication on a first captured image of a specific visitor at a predetermined point in a predetermined facility; a reserved seat identification unit that identifies a position of a reserved seat of the specific visitor based on reserved seat information in which each visitor and a position of a reserved seat of the visitor are associated with each other when the face authentication is successful; a route identification unit that identifies a movement route from the predetermined point to the identified position of the reserved seat based on seat information defining arrangement of a plurality of seats in the facility; and an output unit that outputs guidance information for guidance of the movement route.

### TECHNICAL FIELD

The present invention relates to a seat guidance device, a system, a method, and a non-transitory computer-readable medium having a program stored thereon.

### BACKGROUND ART

Patent Literature 1 discloses a technique concerning a service providing system for improving a service provided to visitors. The service providing system stores, in a storage unit, a person scheduled to visit and a seat for the person in association with each other, in reservation of reserved seats in event watching. When receiving a plurality of pieces of order information, the service providing system performs arithmetic processing on these pieces of order information, generates a sales route by which a salesclerk can move efficiently, and transmits order reception information to an information communication device owned by a salesclerk.

### CITATION LIST

### Patent Literature

Patent Literature 1: Japanese Unexamined Patent Application Publication No. 2018-142080

### SUMMARY OF INVENTION

### Technical Problem

Herein, in a facility with a large number of seats, there is a problem that it is difficult to know, from an entrance place, a seat of oneself and a movement route in a case of having a right of a reserved seat. Patent Literature 1 cannot solve this problem.

The present disclosure has been made in order to solve such a problem, and an object of the present disclosure is to provide a seat guidance device, a system, a method, and a program that enable a visitor to easily understand a movement route to a reserved seat of the visitor.

### Solution to Problem

A seat guidance device according to the present disclosure includes: an authentication control means for causing an authentication device to perform face authentication on a first captured image of a specific visitor at a predetermined point in a predetermined facility, the authentication device storing registered face feature information of a plurality of visitors; a reserved seat identification means for identifying a position of a reserved seat of the specific visitor based on reserved seat information in which each visitor and a position of a reserved seat of the visitor are associated with each other when the face authentication is successful; a route identification means for identifying a movement route from the predetermined point to the identified position of the reserved seat based on seat information defining arrangement of a plurality of seats in the facility; and an output means for outputting guidance information for guidance of the movement route.

A seat guidance device according to the present disclosure includes: a storage means for storing registered face feature information of a plurality of visitors; an authentication means for performing, by using the registered face feature information, face authentication on a first captured image of a specific visitor at a predetermined point in a predetermined facility; a reserved seat identification means for identifying a position of a reserved seat of the specific visitor based on reserved seat information in which each visitor and a position of a reserved seat of the visitor are associated with each other when the face authentication is successful; a route identification means for identifying a movement route from the predetermined point to the identified position of the reserved seat based on seat information defining arrangement of a plurality of seats in the facility; and an output means for outputting guidance information for guidance of the movement route.

A seat guidance system according to the present disclosure includes: a seat guidance device; and an authentication device including a storage means configured to store registered face feature information of a plurality of visitors and an authentication means configured to perform face authentication using the registered face feature information, wherein the seat guidance device is configured to: cause the authentication device to perform face authentication on a first captured image of a specific visitor at a predetermined point in a predetermined facility; identify a position of a reserved seat of the specific visitor based on reserved seat information in which each visitor and a position of a reserved seat of the visitor are associated with each other when the face authentication is successful; identify a movement route from the predetermined point to the identified position of the reserved seat based on seat information defining arrangement of a plurality of seats in the facility; and output guidance information for guidance of the movement route.

A seat guidance method according to the present disclosure includes, by a computer: causing an authentication device to perform face authentication on a first captured image of a specific visitor at a predetermined point in a predetermined facility, the authentication device storing registered face feature information of a plurality of visitors; identifying a position of a reserved seat of the specific visitor based on reserved seat information in which each visitor and a position of a reserved seat of the visitor are associated with each other when the face authentication is successful; identifying a movement route from the predetermined point to the identified position of the reserved seat based on seat information defining arrangement of a plurality of seats in the facility; and outputting guidance information for guidance of the movement route.

A seat guidance method according to the present disclosure includes, by a computer storing registered face feature information of a plurality of visitors: performing, by using the registered face feature information, face authentication on a first captured image of a specific visitor at a predetermined point in a predetermined facility; identifying a position of a reserved seat of the specific visitor based on reserved seat information in which each visitor and a position of a reserved seat of the visitor are associated with each other when the face authentication is successful; identifying a movement route from the predetermined point to the identified position of the reserved seat based on seat information defining arrangement of a plurality of seats in the facility; and outputting guidance information for guidance of the movement route.

A seat guidance program according to the present disclosure causes a computer to execute: processing of causing an authentication device to perform face authentication on a first captured image of a specific visitor at a predetermined point in a predetermined facility, the authentication device storing registered face feature information of a plurality of visitors; processing of identifying a position of a reserved seat of the specific visitor based on reserved seat information in which each visitor and a position of a reserved seat of the visitor are associated with each other when the face authentication is successful; processing of identifying a movement route from the predetermined point to the identified position of the reserved seat based on seat information defining arrangement of a plurality of seats in the facility; and processing of outputting guidance information for guidance of the movement route.

A seat guidance program according to the present disclosure causes a computer storing registered face feature information of a plurality of visitors to execute: processing of performing, by using the registered face feature information, face authentication on a first captured image of a specific visitor at a predetermined point in a predetermined facility; processing of identifying a position of a reserved seat of the specific visitor based on reserved seat information in which each visitor and a position of a reserved seat of the visitor are associated with each other when the face authentication is successful; processing of identifying a movement route from the predetermined point to the identified position of the reserved seat based on seat information defining arrangement of a plurality of seats in the facility; and processing of outputting guidance information for guidance of the movement route.

### Advantageous Effects of Invention

The present disclosure can provide a seat guidance device, a system, a method, and a program that enable a visitor to easily understand a movement route to a reserved seat of the visitor.

### BRIEF DESCRIPTION OF DRAWINGS

FIG. 1 is a block diagram illustrating a configuration of a seat guidance device according to a first example embodiment;

FIG. 2 is a flowchart illustrating a flow of a seat guidance method according to the first example embodiment;

FIG. 3 is a block diagram illustrating a configuration of a seat guidance device according to a second example embodiment;

FIG. 4 is a block diagram illustrating a configuration of a seat guidance system according to a third example embodiment;

FIG. 5 is a block diagram illustrating a configuration of an authentication device in the third example embodiment;

FIG. 6 is a flowchart illustrating a flow of face information registration processing in the third example embodiment;

FIG. 7 is a flowchart illustrating a flow of face authentication processing in the third example embodiment;

FIG. 8 is a block diagram illustrating a configuration of a face authentication terminal in the third example embodiment;

FIG. 9 is a block diagram illustrating a configuration of a user terminal in the third example embodiment;

FIG. 10 is a block diagram illustrating a configuration of a seat guidance device according to the third example embodiment;

FIG. 11 is a sequence diagram illustrating a flow of a seat guidance method according to the third example embodiment;

FIG. 12 is a schematic diagram illustrating an example of a facility X;

FIG. 13 is a schematic diagram illustrating an example of a route identified by the seat guidance system according to the third example embodiment;

FIG. 14 is a block diagram illustrating a configuration of a seat guidance device according to a fourth example embodiment;

FIG. 15 is a schematic diagram illustrating a first example of a route identified by a seat guidance system according to the fourth example embodiment;

FIG. 16 is a schematic diagram illustrating a second example of a route identified by the seat guidance system according to the fourth example embodiment;

FIG. 17 is a block diagram illustrating a configuration of a seat guidance system according to a fifth example embodiment; and

FIG. 18 is a schematic diagram illustrating an outline of operation of the seat guidance system according to the fifth example embodiment.

### EXAMPLE EMBODIMENT

Hereinafter, example embodiments of the present disclosure are described in detail with reference to the drawings. The same or corresponding elements are designated by the same reference signs in the respective drawings, and overlapping description is omitted depending on necessity, for clarification of description.

### First Example Embodiment

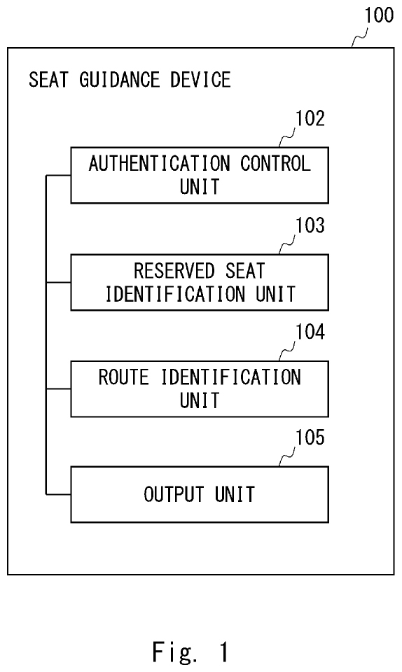

FIG. 1 is a block diagram illustrating a configuration of a seat guidance device 100 according to the first example embodiment. The seat guidance device 100 includes an authentication control unit 102, a reserved seat identification unit 103, a route identification unit 104, and an output unit 105. The seat guidance device 100 is connected to a network 500 (not illustrated). The network 500 may be wired or wireless one. An unillustrated authentication device 200 is connected to the network 500.

The authentication control unit 102 causes the authentication device 200 to perform face authentication on a first captured image of a specific visitor U at a predetermined point Y in a facility X. Herein, it is assumed that the authentication device 200 stores face feature information of a plurality of visitors. The predetermined point Y may be an entrance of the facility X. Examples of the facility X include a baseball stadium, an athletics stadium, and the like.

When the authentication control unit 102 succeeds in the face authentication, the reserved seat identification unit 103 identifies a position of a reserved seat of the specific visitor U, based on reserved seat information 112. The reserved seat information 112 associates each visitor and a position of a reserved seat of the visitor with each other. An example of the reserved seat information 112 is information in which user IDs and the numbers of reserved seats are associated with each other. The route identification unit 104 identifies, based on seat information 111, a movement route from the predetermined point Y to the position of the reserved seat identified by the reserved seat identification unit 103. The seat information 111 defines arrangement of a plurality of seats in the predetermined facility X. The seat information 111 may include information concerning pathways in the facility.

The output unit 105 outputs guidance information for guidance of the movement route identified by the reserved seat identification unit 103. The guidance information may be information that indicates, in a seating chart based on the seat information 111, the movement route identified by the route identification unit 104. The guidance information may be information that indicates an advancing direction. The output unit 105 may output the guidance information to a face authentication terminal, or may output the guidance information to a user terminal owned by the visitor.

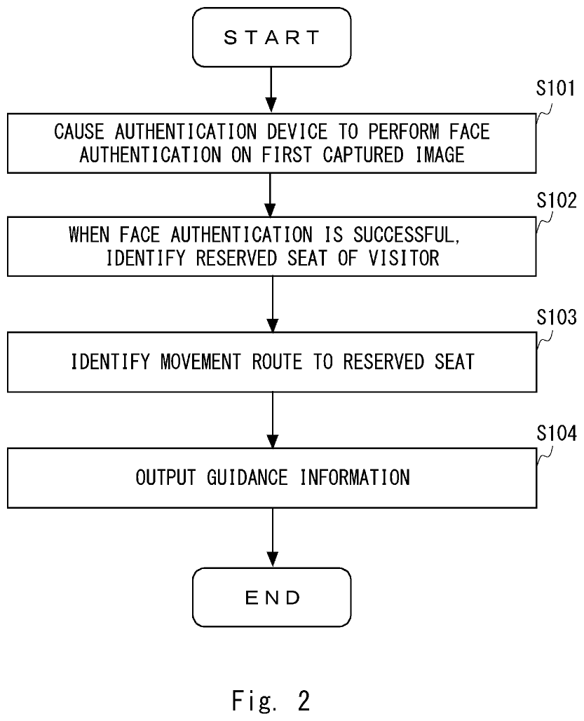

FIG. 2 is a flowchart illustrating a flow of an information processing method according to the first example embodiment. First, the authentication control unit 102 causes the authentication device 200 storing registered face feature information of a plurality of visitors, to perform face authentication on the first captured image of a specific visitor U at the predetermined point Y in the facility X (step S101). It is assumed that the first captured image includes at least a face region of the user U. Next, when the face authentication at the step S101 is successful, the reserved seat identification unit 103 identifies a position of a reserved seat of the specific visitor U, based on the reserved seat information 112 (step S102). Next, the route identification unit 104 identifies, based on the seat information 111, a movement route from the predetermined point Y to the position of the reserved seat identified at the step S102 (step S103). Lastly, the output unit 105 outputs guidance information for guidance of the movement route identified at the step S103 (step S104).

As described above, visitors have not been able to easily understand movement routes to their reserved seats, so far. In contrast to this, the seat guidance device according to the present example embodiment can present, to a visitor identified by face authentication, guidance information for guidance of a route to a reserved seat.

The seat guidance device 100 includes, as unillustrated constituents, a processor, a memory, and a storage device. The storage device stores a computer program in which processing of the seat guidance method according to the present example embodiment is implemented. The processor causes the computer program to be read from the storage device into the memory, and executes the computer program. Thereby, the processor implements the functions of the authentication control unit 102, the reserved seat identification unit 103, the route identification unit 104, and the output unit 105.

The authentication control unit 102, the reserved seat identification unit 103, the route identification unit 104, and the output unit 105 may be each implemented by dedicated hardware. A part or entirety of each constituent element of each device may be implemented by general-purpose or dedicated circuitry, a processor, or the like, or a combination thereof. These may be constituted of a single chip, or may be constituted of a plurality of chips connected to each other via a bus. A part or entirety of each constituent element of each device may be implemented by a combination of the above-described circuitry or the like and a program. A central processing unit (CPU), a graphics processing unit (GPU), a field-programmable gate array (FPGA), or the like can be used as the processor.

When a part or entirety of each constituent element of the seat guidance device 100 is implemented by a plurality of information processing devices, pieces of circuitry, or the like, a plurality of the information processing devices, the pieces of circuitry, or the like may be arranged in a concentrated manner, or may be arranged in a distributed manner. For example, these information processing devices, circuitries, or the like may be implemented in a mode in which they are connected to each other via a communication network, as in, for example, a client server system or a cloud computing system. The functions of the seat guidance device 100 may be provided in a form of software as a service (SaaS).

### Second Example Embodiment

The second example embodiment is a modified example of the above-described first example embodiment. According to the seat guidance device 100 of the first example embodiment, personal authentication is performed by the external authentication device 200. Meanwhile, according to a seat guidance device 100 of the second example embodiment, personal authentication is performed inside the device.

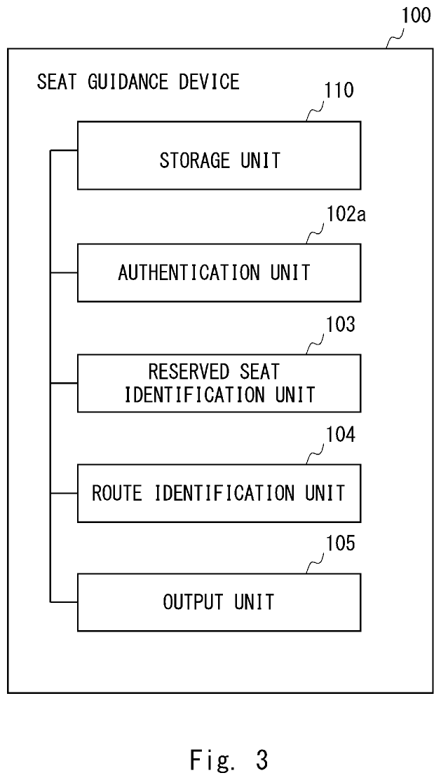

FIG. 3 is a block diagram illustrating a configuration of the seat guidance device 100 according to the second example embodiment. The seat guidance device 100 includes a storage unit 110, an authentication unit 102a, a reserved seat identification unit 103, a route identification unit 104, and an output unit 105. Functions of the reserved seat identification unit 103, the route identification unit 104, and the output unit 105 are similar to those in the first example embodiment, and thus, description thereof is omitted.

The storage unit 110 in the second example embodiment stores registered face feature information of a plurality of visitors. The authentication unit 102a in the second example embodiment performs face authentication on a first captured image by using a plurality of the pieces of the registered face feature information stored by the storage unit 110.

A flow of the information processing method according to the second example embodiment is similar to that in FIG. 2. However, at the step S101, the authentication unit 102a performs face authentication on the first captured image by using the registered face feature information.

Thus, the second example embodiment also can achieve the advantageous effect similar to that of the above-described first example embodiment.

### Third Example Embodiment

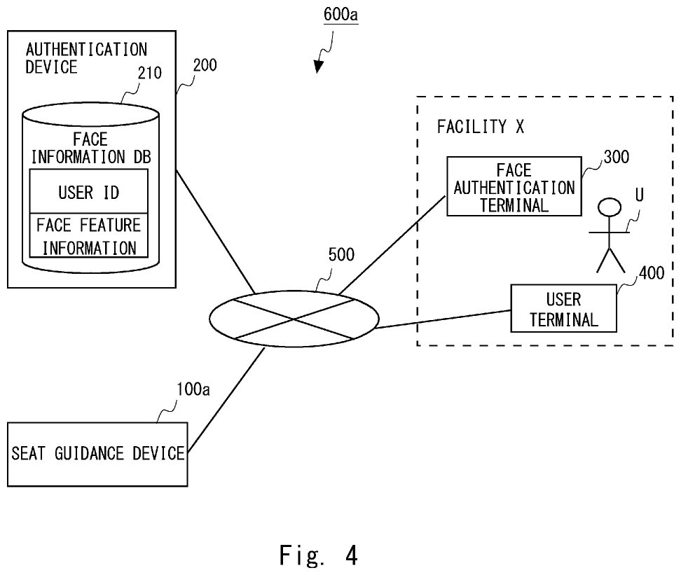

The third example embodiment is a specific example of the above-described first example embodiment. FIG. 4 is a block diagram illustrating a configuration of a seat guidance system 600a according to the third example embodiment. The seat guidance system 600a includes a seat guidance device 100a, an authentication device 200, a face authentication terminal 300, and a user terminal 400. The seat guidance device 100a, the authentication device 200, the face authentication terminal 300, and the user terminal 400 are connected to one another via a network 500. In the third example embodiment, it is assumed that registered face feature information of a plurality of visitors is registered in the authentication device 200 in advance.

The seat guidance device 100a performs face authentication of a visitor U in the facility X, and outputs a route leading to a reserved seat of the visitor U. Each function of the seat guidance device 100a is described below. The authentication device 200 includes a face information DB 210. The face feature DB 210 stores a user ID and the face feature information of the user in association with each other. The face information DB 210 is referred to also as a storage unit. In response to a face authentication request received from an outside, the authentication device 200 compares a face image or face feature information included in the request, with the face feature information of each user, and sends, to a request source, the comparison result as a reply.

The face authentication terminal 300 is a terminal device that performs face authentication on the visitor U, in the facility X. The face authentication terminal 300 is digital signage, for example. The face authentication terminal 300 may be installed at an entrance of the facility X, for example. The face authentication terminal 300 displays guidance information for guidance of a route to a reserved seat of the user U. The seat guidance system 600a may cause the guidance information to be displayed on the user terminal 400.

The user terminal 400 is a terminal owned by the user U. Examples of the user terminal 400 include a mobile phone terminal, a smartphone, a tablet terminal, a personal computer (PC) equipped with or connected to a camera, and the like. The user terminal 400 transmits, to the authentication device 200, a registration image used for face authentication of the user U, and thereby performs a face information registration request. The user terminal 400 may transmit, to the authentication device 200, face feature information extracted from the registration image, and thereby performs the face information registration request. Further, the user terminal 400 may receive the guidance information from the seat guidance device 100a.

In other words, the user terminal 400 is a device that registers, in the face information DB 210, the face feature information extracted from the face image of the user U, before the below-described face authentication is performed. The user U may register the face feature information by using a device other than the user terminal 400. For example, the user U may register the face feature information by a face authentication terminal having the above-described face information registration request function.

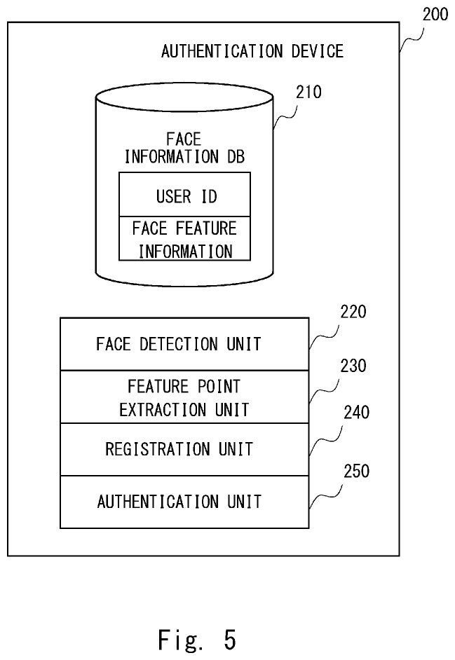

Next, the function of the authentication device 200 is described in detail. FIG. 5 is a block diagram illustrating a configuration of the authentication device 200. The authentication device 200 includes the above-described face information DB 210, a face detection unit 220, a feature point extraction unit 230, a registration unit 240, and an authentication unit 250.

The face detection unit 220 detects a face region included in the registration image used for registering the face feature information, and outputs the face region to the feature point extraction unit 230. The feature point extraction unit 230 extracts feature points from the face region detected by the face detection unit 220, and outputs the face feature information to the registration unit 240. Herein, the face feature information is a set of the extracted feature points. The feature point extraction unit 230 extracts feature points included in a face image received from the seat guidance device 100a, and thereby outputs face feature information to the authentication unit 250.

The registration unit 240 newly issues a user ID when registering face feature information. The registration unit 240 registers the issued user ID and the face feature information extracted from a registration image, in association with each other, in the face information DB 210. The authentication unit 250 compares face feature information extracted from a face image, with the face feature information in the face information DB 210. The authentication unit 250 sends, to the seat guidance device 100a, a reply that indicates matching or un-matching of the face feature information. The matching or un-matching of the face feature information corresponds to success or failure in the authentication.

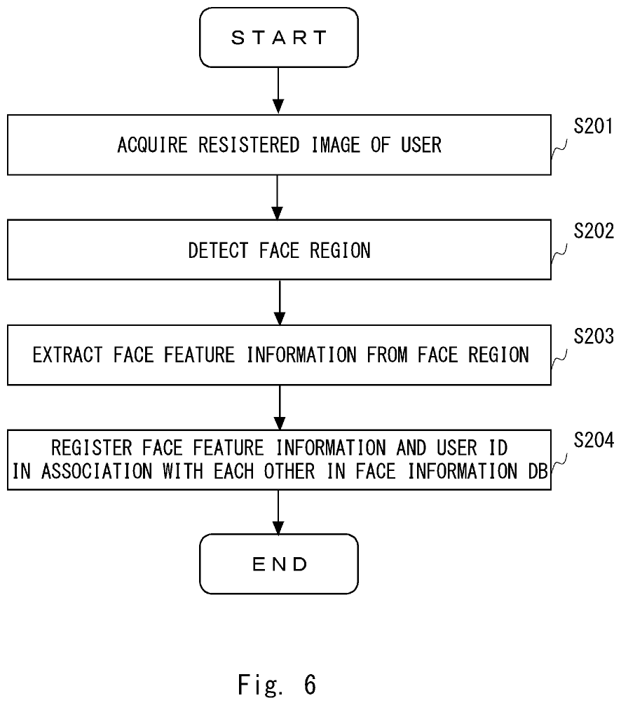

FIG. 6 is a flowchart illustrating a flow of face information registration processing by the authentication device 200. First, the authentication device 200 acquires a registration image included in a face information registration request (step S201). For example, the authentication device 200 receives the face information registration request from the user terminal 400 or the like via a network 500. Next, the face detection unit 220 detects a face region included in the registration image (step S202). Next, the feature point extraction unit 230 extracts feature points from the face region detected at the step S202, and outputs the face feature information to the registration unit 240 (step S203). Lastly, the registration unit 240 issues a user ID, and registers the user ID and the face feature information in association with each other in the face information DB 210 (step S204). The authentication device 200 may receive face feature information from the user terminal 400 or the like, and may register the received face feature information in association with a user ID, in the face information DB 210.

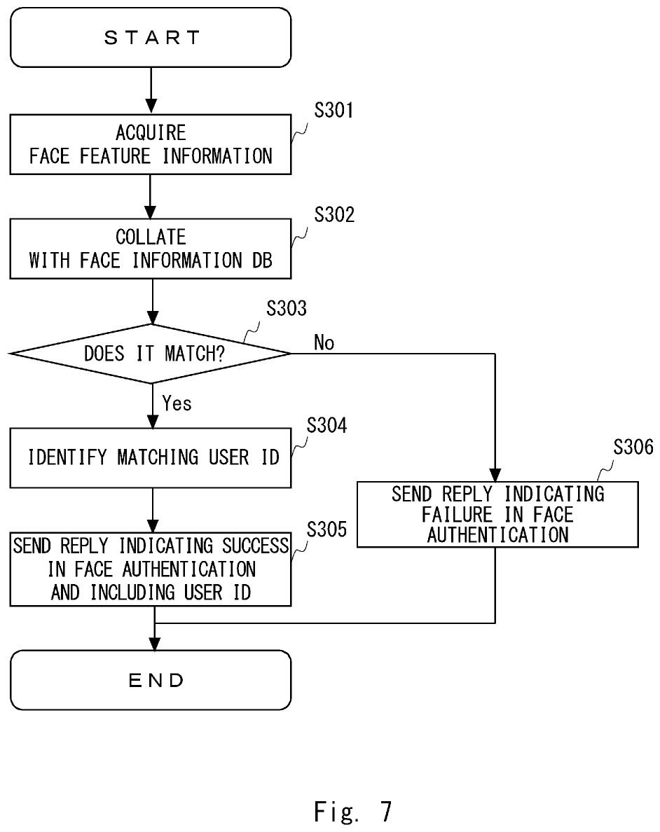

FIG. 7 is a flowchart illustrating a flow of face authentication processing by the authentication device 200. First, the feature point extraction unit 230 acquires face feature information from a face image received from the seat guidance device 100a (step S301). For example, the authentication device 200 receives a face image from the seat guidance device 100a, and extracts the face feature information as in the steps S201 to S203. Alternatively, the authentication device 200 may receive face feature information from the seat guidance device 100a. Next, the authentication unit 250 compares the acquired face feature information with the face information DB 210 (step S302). When the face feature information is matched (yes at the step S303), the authentication unit 250 identifies the user ID of a user whose face feature information is matched (step S304), and sends, to the seat guidance device 100a, a reply indicating success in the face authentication and including the identified user ID (step S305). When matched face feature information does not exist (no at the step S303), the authentication unit 250 sends, to the seat guidance device 100a, a reply indicating failure in the face authentication (step S306).

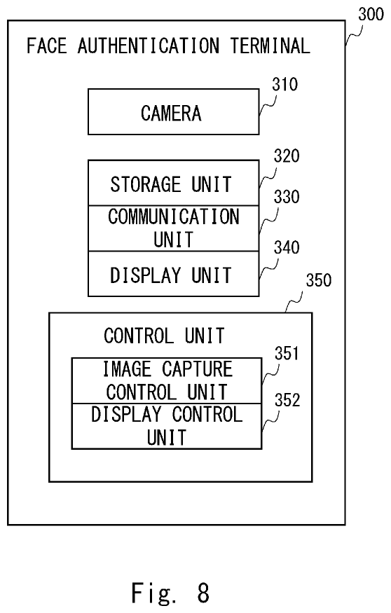

Next, the face authentication terminal 300 is described in detail. The face authentication terminal 300 includes, as hardware constituents, an image capture device such as a camera, a display, and a computer. FIG. 8 is a block diagram illustrating a configuration of the face authentication terminal 300.

The face authentication terminal 300 includes the above-described camera 310, a storage unit 320, a communication unit 330, a display unit 340, and a control unit 350. The storage unit 320 is a storage device that stores a program for implementing each function of the face authentication terminal 300. The communication unit 330 is a communication interface with the network 500. The display unit 340 is the above-described display. The control unit 350 controls the hardware included in the face authentication terminal 300. The control unit 350 includes an image capture control unit 351 and a display control unit 352.

The image capture control unit 351 controls the camera 310, thereby capturing an image of a user subjected to face authentication, and transmits the captured image to the seat guidance device 100a, thereby causing the seat guidance device 100a to perform face authentication. The captured image is an image including at least an image of a face of the user.

The display control unit 352 displays guidance information in response to an instruction from the seat guidance device 100a. For example, the guidance information may be information indicating a specific movement route in a seating chart, or may be information simply indicating a movement direction. The seat guidance system 600a can use either the face authentication terminal 300 or the user terminal 400, as a device for displaying the guidance information.

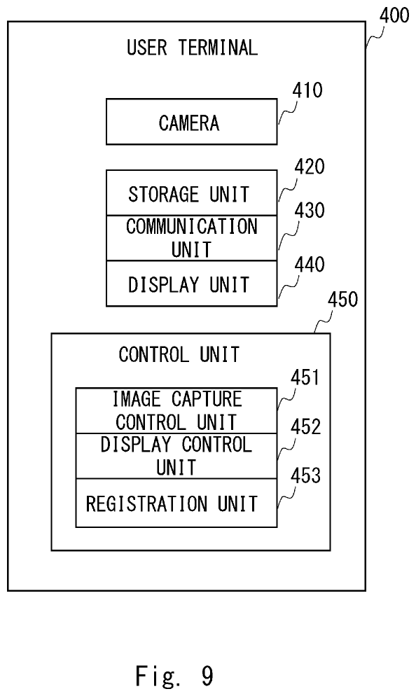

Next, the user terminal 400 is described. The user terminal 400 is a mobile phone terminal or the like owned by the user. FIG. 9 is a block diagram illustrating a configuration of the user terminal 400. The user terminal 400 includes a camera 410, a storage unit 420, a communication unit 430, and a display unit 440. The user terminal 400 includes a control unit 450 that controls the above-described hardware. The control unit 450 includes an image capture control unit 451, a display control unit 452, and a registration unit 453.

The image capture control unit 451 controls the camera 410, thereby capturing an image of the user subjected to face registration, and outputs the captured image to the registration unit 453. The captured image is an image including at least an image of a face of the user. The image capture control unit 451 may control the camera 410, thereby capturing an image of an inside of the facility X. In such a case, the seat guidance device 100a can output a combined image in which an indication image indicating a seat is combined with the image of the inside of the facility X.

The display control unit 452 receives guidance information from the seat guidance device 100a and displays the guidance information on the display unit 440, similarly to the display control unit 352 of the face authentication terminal 300. The seat guidance system 600a can use either the face authentication terminal 300 or the user terminal 400, as a device for displaying the guidance information. The registration unit 453 performs a face information registration request.

The following describes the flow of the face information registration processing. First, the image capture control unit 451 controls the camera 410, thereby capturing a registration image of the user. Next, the registration unit 453 transmits a face information registration request including the registration image, to the authentication device 200 via the network 500. The registration unit 453 may receive a registered user ID as a registration result from the authentication device 200. The registration unit 453 may transmit, to the authentication device 200, a face information registration request including face feature information extracted from the registration image.

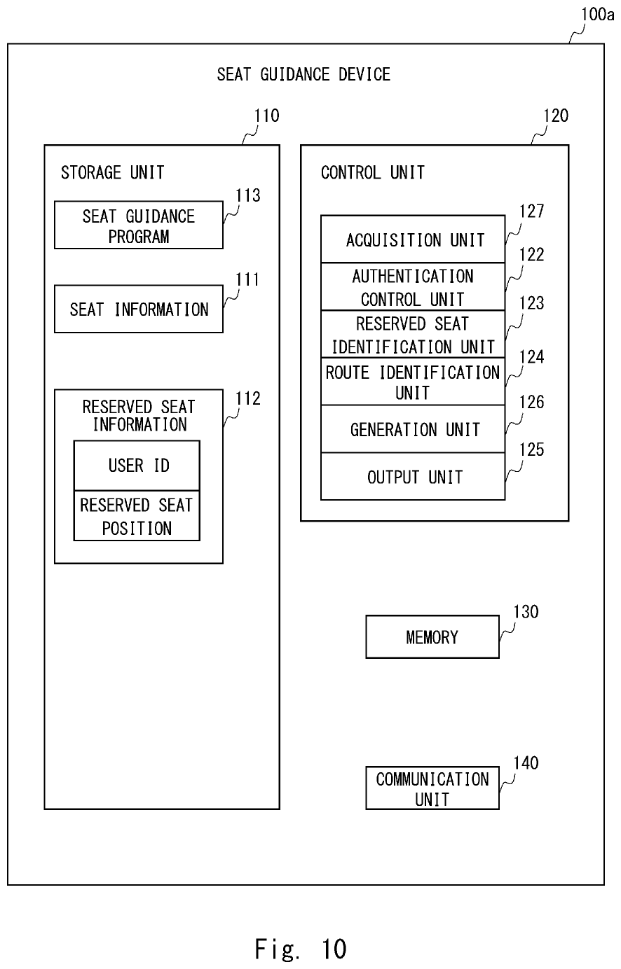

Next, the functions of the seat guidance device 100a are described with reference to FIG. 10. The seat guidance device 100a is an information processing device that outputs a route leading to a reserved seat of a visitor U to the facility X, and for example, is a server device implemented by a computer. As illustrated in FIG. 10, the seat guidance device 100a includes the storage unit 110, a control unit 120, a memory 130, and a communication unit 140.

The storage unit 110 is a storage device such as a hard disk or a flash memory. The control unit 120 controls each function of the seat guidance device 100a. The memory 130 is a volatile storage device such as a random-access memory (RAM), and is a storage area for temporarily holding information at the time the control unit 120 operates. The communication unit 140 is a communication interface with the network 500.

The storage unit 110 stores at least a seat guidance program 113, seat information 111, and the reserved seat information 112. The seat guidance program 113 is a computer program in which a seat guidance method according to the present example embodiment is implemented.

The seat information 111 is information that defines arrangement of a plurality of seats in the facility X. The seat information 111 may include route information concerning a route to each seat. The below-described route identification unit 124 identifies a route to an identified reserved seat, based on the seat information 111. The reserved seat information 112 is information in which a user ID of a user who visits the facility X is associated with a reserved seat position of the user. The reserved seat position is a seat number that identifies a seat. Based on the reserved seat information 112, the below-described reserved seat identification unit 123 identifies the reserved seat of the user U who has visited.

The control unit 120 reads the seat guidance program 113 from the storage unit 110 into the memory 130, and executes the seat guidance program 113. Thereby, the control unit 120 implements the functions of an acquisition unit 127, an authentication control unit 122, the reserved seat identification unit 123, the route identification unit 124, a generation unit 126, and an output unit 125. The authentication control unit 122 is one example of the authentication control unit 102, the reserved seat identification unit 123 is one example of the reserved seat identification unit 103, the route identification unit 124 is one example of the route identification unit 104, and the output unit 125 is one example of the output unit 105.

The acquisition unit 127 acquires a first captured image of a visitor that is captured by the face authentication terminal 300. The authentication control unit 122 causes the authentication device 200 to perform face authentication on the first captured image acquired by the acquisition unit 127. The reserved seat identification unit 123 identifies, in the reserved seat information 112, a reserved seat associated with a user U whose face authentication is successful.

The route identification unit 124 identifies, based on the seat information 111, a movement route to the reserved seat identified by the reserved seat identification unit 123. The route identification unit 124 can identify a movement route to each reserved seat by using a known search algorithm. The route identification unit 124 may identify a plurality of movement routes, and may assign priority levels to the respective movement routes. The priority levels may be determined based on route lengths of the respective movement routes, for example.

The generation unit 126 generates guidance information for guidance of the route identified by the route identification unit 124. The generation unit 126 may generate the guidance information that indicates the movement route in a seating chart based on the seat information 111. The guidance information may be information simply indicating a movement direction, instead of indicating a movement route.

The output unit 125 outputs the guidance information generated by the generation unit 126. The output destination may be the face authentication terminal 300 or the user terminal 400. For example, the output unit 125 may output the guidance information to the user terminal 400, based on a user ID included in an authentication result received from the authentication device 200. Herein, it is assumed that the user has already logged in to the user terminal 400 by using a user ID.

When the route identification unit 124 identifies a plurality of movement routes, the output unit 125 outputs a plurality of the movement routes, based on priority levels. For example, the output unit 125 may output guidance information that represents, in a seating chart, the high-priority-level route in red and the low-priority-level route in blue. The output unit 125 may output a list in which seating charts including the movement routes are arranged in the order of the priority levels.

The control unit 120 may have a function of outputting a combined image in which a captured image, captured by the user terminal 400, of a group of seats in the facility X is combined with an indication image indicating a reserved seat of a visitor U. The indication image is, for example, an image of an arrow indicating the seat. The control unit 120 combines the captured image with the indication image by using a technique of augmented reality. For example, the control unit 120 may read a marker such as a QR code (registered trademark) arranged at each seat, and may thereby arrange, in the captured image, the indication image indicating the reserved seat of the visitor U.

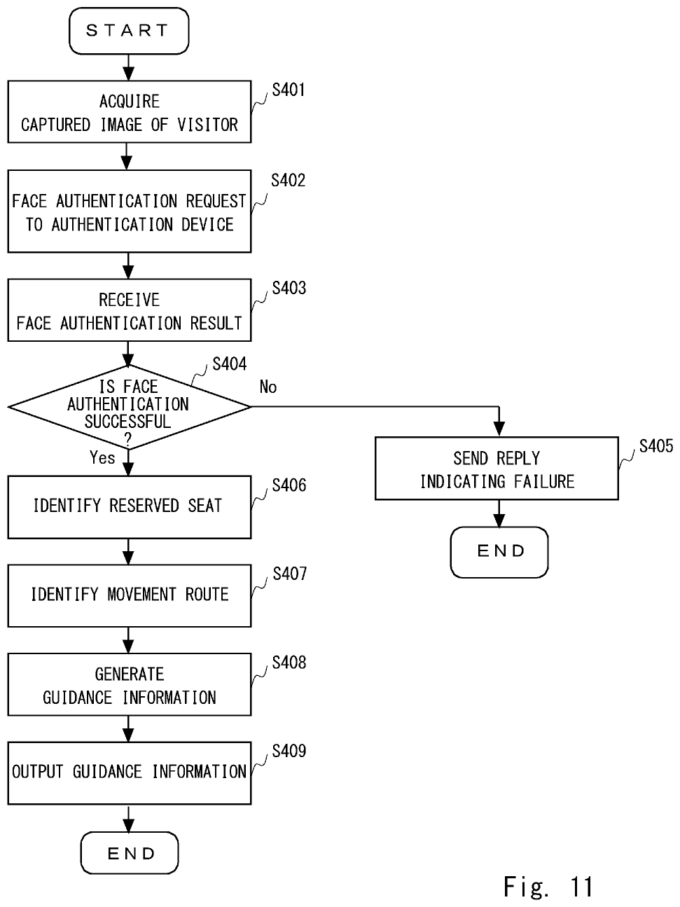

FIG. 11 is a flowchart illustrating operation of the seat guidance device 100a according to the present example embodiment. First, the acquisition unit 127 of the seat guidance device 100a acquires, from the face authentication terminal 300, a first captured image, at the point Y, of a user U who has visited (step S401). Next, the authentication control unit 122 of the seat guidance device 100a transmits a face authentication request to the authentication device 200, thereby causing the authentication device 200 to perform face authentication (step S402). Next, the authentication control unit 122 of the seat guidance device 100a receives, from the authentication device 200, as an authentication result, information indicating success or failure in the authentication by the authentication device 200 and including a user ID of the authenticated user U (step S403).

Next, the authentication control unit 122 of the seat guidance device 100a determines whether or not the face authentication is successful, based on the received face authentication result (step S404). When the face authentication is unsuccessful (no at the step S404), the seat guidance device 100a sends a reply indicating failure in the face authentication (step S405), and ends the processing.

When the face authentication is successful (yes at the step S404), the reserved seat identification unit 123 of the seat guidance device 100a identifies, in the reserved seat information 112, a reserved seat associated with the user ID received at the step S403 (step S406). Next, the route identification unit 124 identifies a route from the point Y to the reserved seat identified at the step S406 (step S407).

Next, the generation unit 126 generates guidance information for guidance of the route identified at the step S407 (step S408). The guidance information may be information indicating a direction to advance from the point Y, or may be information indicating a route in a seating chart based on the seat information 111. Lastly, the output unit 125 outputs the guidance information generated at the step S408 (step S409).

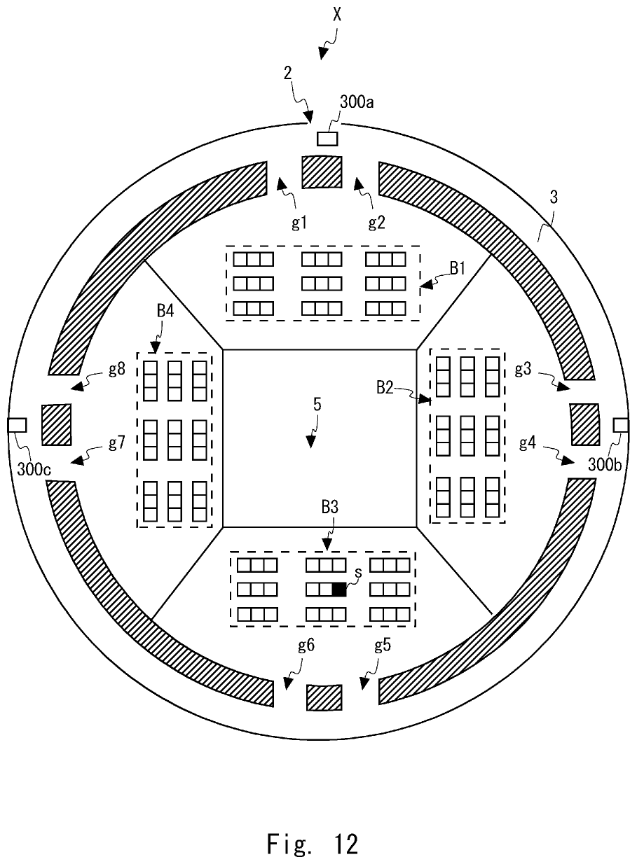

Next, an operation example of the seat guidance system 600a is described with reference to FIG. 12. The facility X illustrated in FIG. 12 is a stadium. Visitors to the facility X move clockwise or counterclockwise on a pathway 3, pass through one of gates g1 to g8, and take their seats. In FIG. 12, groups of a plurality of seats are referred to as a block B1 to a block B4. The seats surround a sport area 5 in the facility X. Face authentication terminals 300a, 300b, and 300c are installed in the facility X. The face authentication terminals 300a, 300b, and 300c may be signage attached to pillars arranged in the pathway 3.

A visitor U who has visited the facility X captures a first captured image at an entrance 2 by using the face authentication terminal 300. The authentication control unit 122 causes the authentication device 200 to perform face authentication on the first captured image. Next, the reserved seat identification unit 123 identifies, in the reserved seat information 112, a reserved seat associated with the visitor U. Hereinafter, it is assumed that the reserved seat identification unit 123 has identified a reserved seat s in the block B3.

The route identification unit 124 identifies a route to the reserved seat s, based on the seat information 111. For example, the route identification unit 124 identifies the route of moving clockwise on the pathway 3 and moving through the gate g5 to the reserved seat s.

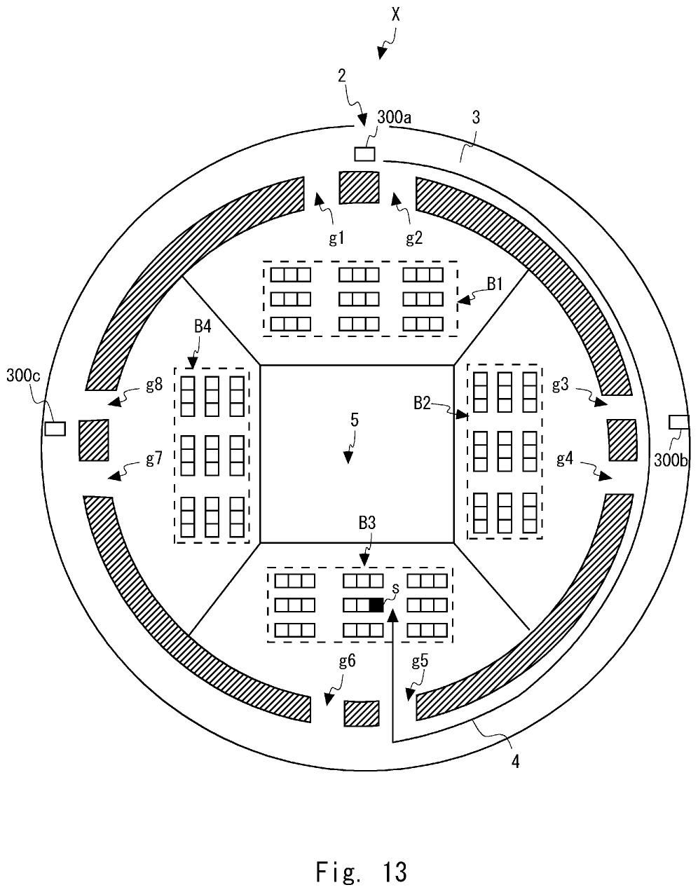

FIG. 13 is a schematic diagram illustrating an example of a route identified by the route identification unit 124. The route identification unit 124 identifies a route 4 having the shortest length from the entrance 2. The output unit 125 outputs, to the face authentication terminal 300a or the like, guidance information for guidance of the route 4. The output unit 125 may output, as the guidance information, a diagram in which a seating chart and the route are combined with each other as in FIG. 13. The output unit 125 may cause the face authentication terminal or the like to display a mark such as an arrow for an instruction of moving clockwise on the pathway 3. The guidance information may include not only a guide map including the seating chart and the route, but also information concerning a seat number, a start time of sport or the like, a view of the sport area 5 from the seat, and the like.

A visitor U can reconfirm the guidance information by using the face authentication terminal 300b, in the course of moving on the route 4. Thus, the visitor U can confirm the guidance information by the face authentication terminal 300a at the entrance 2, and can reconfirm the guidance information by using the different face authentication terminal 300b or 300c, in the course of moving along the guidance information. Herein, the face authentication terminals 300b and 300c may receive the guidance information from the seat guidance device 100a, similarly to the face authentication terminal 300a.

The face authentication terminal 300a may transmit a user ID of a visitor and guidance information in association with each other, to the face authentication terminals 300b and 300c. In such a case, the face authentication terminals 300b and 300c can present the guidance information to the visitor who has been face-authenticated. In this manner, the face authentication terminals may cooperate with each other, thereby providing the guidance information to the visitor.

The seat guidance device 100a may identify a route or assign priority levels to a plurality of routes, in consideration of a desired condition of a visitor. An example of the desired condition is whether or not to use a rest room, a shop, a smoking place, or the like. When a rest room or the like is used, the seat guidance device 100a identifies a route of moving from a current location to a reserved seat via a point based on the desired condition.

Herein, the seat guidance device 100a may identify a route in consideration of waiting time for a rest room, a shop, a smoking place, or the like. For example, when a plurality of rest rooms exist in the facility X, the seat guidance device 100a may identify a route having the shortest total of waiting time for the rest room and movement time of the route.

Concerning a shop, there is a case in which a plurality of shops exist in the facility X, and sell products that are different per shop. In such a case, the seat guidance device 100a can identify a route via the shop, in consideration of a name of a team supported by a visitor, existence or absence of alcohol sale, a kind of foods favorite for the visitor, or the like as the desired conditions of the visitor. The desired condition may be input to the face authentication terminal 300a by the visitor, or may be extracted from a past purchase history of the visitor, or information posted on an SNS by the visitor.

The desired condition may be sport information concerning sport for which watching is desired. In such a case, the seat guidance device 100a may determine a route of arriving in time for the sport for which watching is desired, in consideration of current time, movement time of a pathway, waiting time for a rest room, and the like. Herein, the movement time of the pathway may be determined based on a congestion degree of the pathway. Herein, the seat guidance device 100a can determine the congestion degree from the number of visitors, a captured image of the pathway, or the like.

For example, it is assumed that current time is ten o'clock, start time of a 400 m race is five minutes past ten, and start time of a 1000 m race is twenty minutes past ten. In such a case, the seat guidance device 100a may present, to a visitor wishing to watch the 1000 m race, a route of stopping by at a shop or a rest room and then moving to a seat, and may present, to a visitor wishing to watch the 400 m race, a route of moving to a seat without stopping by at a shop or the like.

The sport information may be information concerning an inning of baseball or the like. Herein, a current inning can be estimated from current time. For example, the seat guidance device 100a may present, to a visitor wishing to watch from a top of a fifth inning, a route of stopping by at a shop or a rest room and then moving to a seat, and may present, to a visitor wishing to watch from a top of a fourth inning, a route of moving to a seat without stopping by at a shop or the like.

The seat guidance device 100a may output guidance information concerning one route or output guidance information concerning a plurality of routes, based on an input of a visitor or a past purchase history. The guidance information concerning a plurality of routes may include a plurality of the routes or a simulation result concerning a plurality of the routes. The simulation result is a result of simulation on time of arrival at a reserved seat and waiting time at a rest room, a shop, or the like. A visitor can select, from a plurality of the routes, the route that the visitor oneself desires.

The seat guidance device 100a according to the present example embodiment identifies a reserved seat associated with a visitor identified by face authentication, and outputs a route leading to the reserved seat. Accordingly, the visitor can easily understand the route to the seat of the visitor.

### Fourth Example Embodiment

The seat guidance device 100a according to the third example embodiment identifies a movement route to a position of a reserved seat identified based on the seat information 111. Meanwhile, the seat guidance device 100a according to the fourth example embodiment identifies a movement route to a position of a reserved seat, further based on the number of visitors who have visited the facility X. A configuration of a seat guidance system 600b according to the fourth example embodiment is similar to that in FIG. 4, and thus, description thereof is omitted.

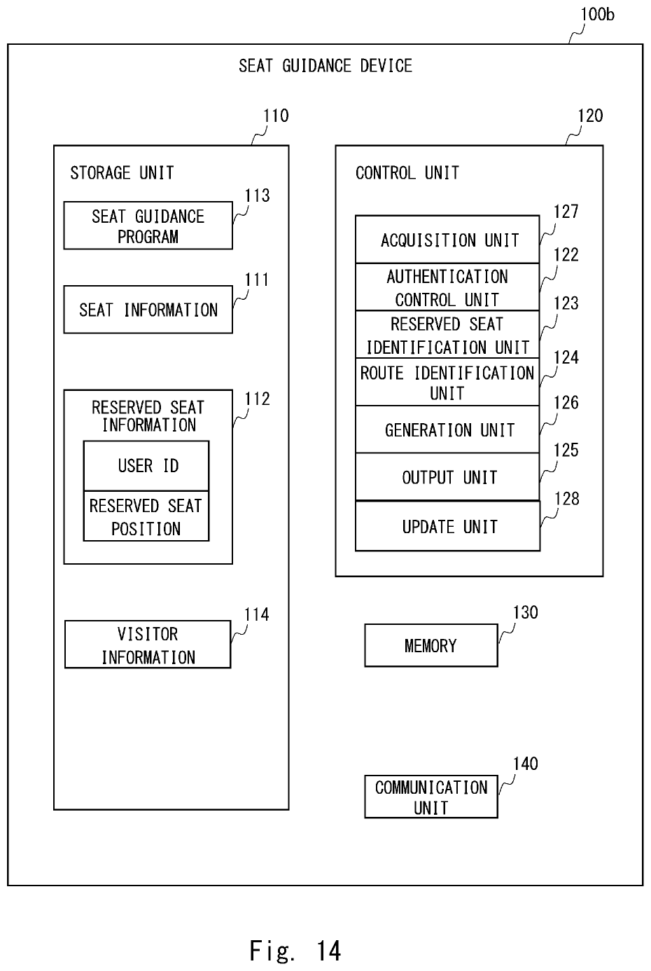

FIG. 14 is a configuration diagram illustrating a configuration of the seat guidance device 100b according to the fourth example embodiment. Functions of the memory 130 and the communication unit 140 are similar to those in FIG. 10, and thus, description thereof is omitted.

The storage unit 110 further stores visitor information 114. The visitor information 114 is information that indicates reserved seats of persons who have entered the facility X. The seat guidance system 600b updates the visitor information 114 by using the below-described update unit 128 after face authentication of a visitor is performed by the face authentication terminal 300 in the facility X.

The control unit 120 includes the acquisition unit 127, the authentication control unit 122, the reserved seat identification unit 123, the route identification unit 124, the generation unit 126, the output unit 125, and the update unit 128. Functions of the acquisition unit 127, the authentication control unit 122, the reserved seat identification unit 123, the generation unit 126, and the output unit 125 are similar to those in the third example embodiment, and thus, description thereof is omitted.

When face authentication by the authentication control unit 122 is successful, the update unit 128 stores, in the storage unit 110, as the visitor information 114, a position of a reserved seat identified by the reserved seat identification unit 123. The route identification unit 124 identifies a movement route, based on the seat information 111 and the visitor information 114.

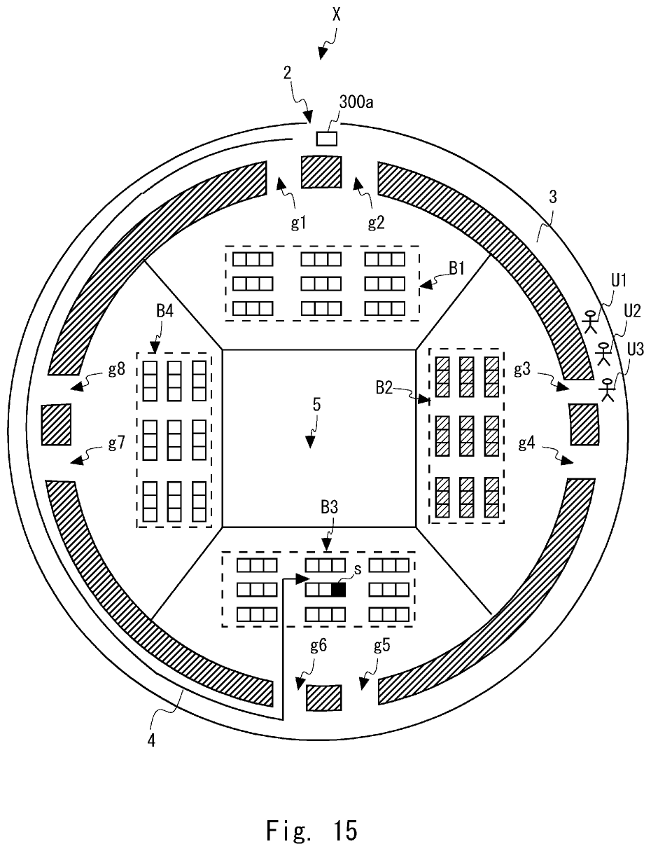

One example of a method of identifying a movement route, based on the seat information 111 and the visitor information 114, is described with reference to FIG. 15. It is assumed that for twenty seven seats in a block B2, persons who had purchased the reserved seats have visited. In such a case, the information of the reserved seats in the block B2 is recorded as the visitor information 114.

The route identification unit 124 identifies a route to a reserved seat s of a visitor U, based on the seat information 111 and the visitor information 114. Herein, a clockwise route of the pathway 3 is expected to be congested with visitors U1, U2, and U3 moving to the seats in the block B2. In such a case, the route identification unit 124 can output a route 4.

The route identification unit 124 may identify a movement route, in consideration of movement routes identified for other visitors. For example, when a clockwise route has been identified for a predetermined number or more of visitors, the route identification unit 124 may output a counterclockwise route to a new visitor U.

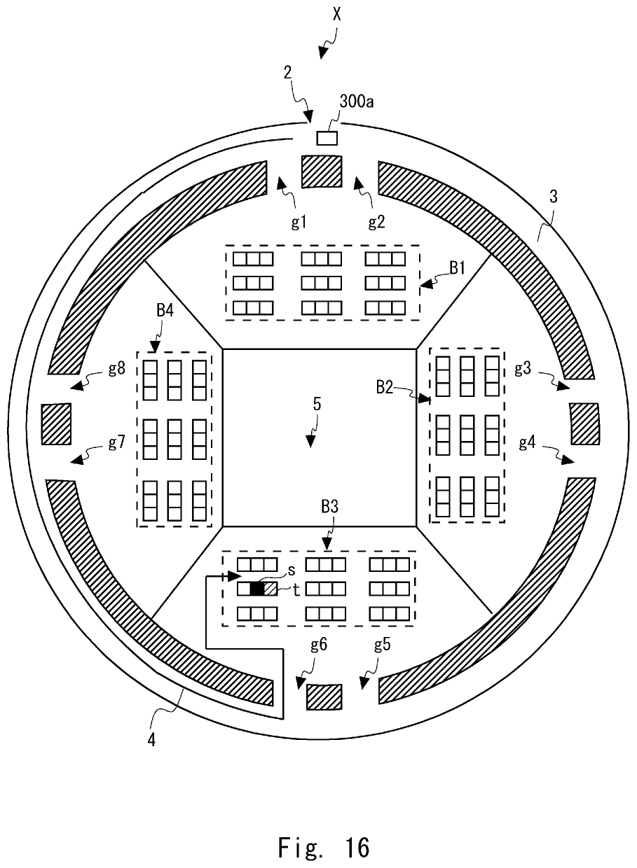

A second example of a method of identifying a movement route, based on the seat information 111 and the visitor information 114, is described with reference to FIG. 16. It is assumed that for a seat t, a person who had already purchased the reserved seat has already visited. In such a case, the information of the seat t is recorded as the visitor information 114. The route identification unit 124 identifies a route to a reserved seat s of a visitor U, based on the seat information 111 and the visitor information 114.

The visitor U can move to the reserved seat s by advancing straight from the gate g6 and passing through the vicinity of the seat t. However, when the person is seated in the reserved seat t, there is a possibility that passing through the vicinity of the reserved seat t is difficult for the visitor U. In such a case, the route identification unit 124 can identify a route 4.

As described above, the visitor information 114 represents a seat for which a person who had purchased the reserved seat has already visited. Herein, there is a possibility that the person is moving as illustrated in FIG. 15, and a possibility that the person is seated as illustrated in FIG. 16. Accordingly, the seat guidance system 600b can present more accurate guidance information by determining whether or not the person is seated. Whether or not a visitor is seated can be determined from a seating sensor installed in each seat or a captured image of an inside of the facility.

In such a case, the storage unit 110 stores seating information indicating that the visitor is seated. The update unit 128 updates the seating information, based on the seating sensor or the captured image. The route identification unit 124 identifies a movement route by using the seating information. In the case of FIG. 15, the route identification unit 124 may identify a movement route from a difference between the visitor information 114 and the seating information. In the case of FIG. 16, the route identification unit 124 may identify a movement route, based on the seating information.

The seat guidance system 600b according to the fourth example embodiment can identify a movement route, in consideration of influence of another visitor on congestion.

### Fifth Example Embodiment

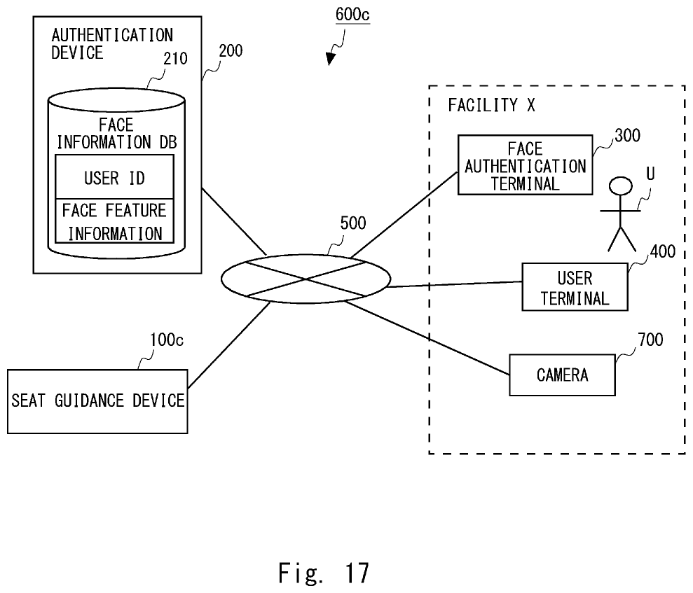

A seat guidance system 600c according to the present fifth example embodiment analyzes a captured image of an inside of the facility X and thereby determines a congestion degree, and outputs a detour route, depending on a result of the determination. FIG. 17 is a block diagram illustrating a configuration of the seat guidance system 600c according to the present fifth example embodiment. A camera 700 is installed in the facility X. The camera 700 captures an image of an area near a route identified by a seat guidance device 100c. A plurality of the cameras 700 may be installed in the facility X.

A configuration diagram of the seat guidance device 100c according to the example embodiment is similar to that of FIG. 10. The following describes matters different from those in the third example embodiment. The acquisition unit 127 acquires, from the camera 700, a second captured image of an area near a route identified by the route identification unit 124. The route identification unit 124 determines, by using a known image analysis technique, a congestion degree from the second captured image acquired by the acquisition unit 127. When the determined congestion degree is equal to or higher than a predetermined value, the route identification unit 124 searches a detour route, and identifies the searched detour route as a movement route.

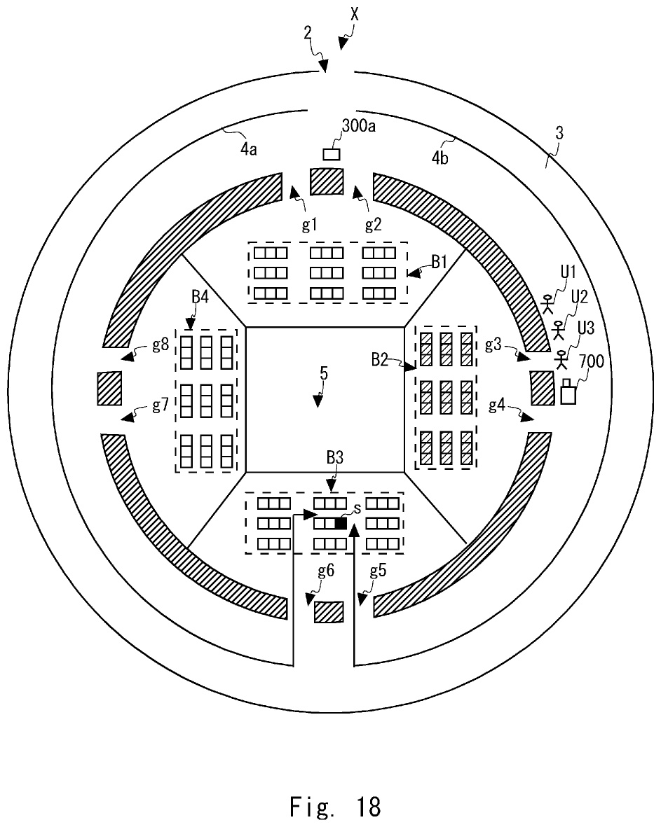

Next, operation of the seat guidance system 600c is described specifically with reference to FIG. 18. It is assumed that when the reserved seat identification unit 123 identifies a reserved seat s, the route identification unit 124 identifies a route 4b. Next, the acquisition unit 127 acquires a second captured image of an area on the path 4b that is captured by using the camera 700. The route identification unit 124 determines whether or not a congestion degree determined from the second captured image exceeds a predetermined value. For example, the route identification unit 124 may determine whether or not the number of persons included in the second captured image exceeds the predetermined value. When the determined congestion degree is equal to or higher than the predetermined value, the route identification unit 124 identifies a detour route 4a as a movement route.

The camera 700 may capture an image of each block. For example, when determining, based on a second captured image, that a route of passing through the gate g5 and advancing straight is congested, the route identification unit 124 may identify a route detouring the block B3 and moving to the seat s from on a side of the sport area 5.

The route identification unit 124 may identify a plurality of movement routes, and assign, to the respective movement routes, priority levels depending on congestion degrees. In such a case, the output unit 125 outputs a plurality of the movement routes, based on the priority levels. For example, the output unit 125 may output guidance information that represents, in a seating chart, the high-priority-level route in red and the low-priority-level route in blue. The output unit 125 may output a list in which seating charts including the movement routes are arranged in the order of the priority levels.

The seat guidance system 600c according to the present fifth example embodiment outputs a detour route, based on a captured image of an area on an identified route. Thus, the seat guidance system 600c can appropriately guide a visitor even when a pathway in a facility is congested.

The above-described example embodiments are described as the hardware configurations, but the present disclosure is not limited to this. The present disclosure can be implemented also by causing a CPU to execute a computer program for arbitrary processing.

In the above-described example, the program can be stored by using any of various types of non-transitory computer-readable media, and can be supplied to a computer. The non-transitory computer-readable media include various types of tangible storage media. Examples of the non-transitory computer-readable media include magnetic recording media (e.g., a flexible disk, a magnetic tape, and a hard disk drive), magneto-optical recording media (e.g., a magneto-optical disk), a compact disk read-only memory (CD-ROM), a CD-R. a CD-RW, a digital versatile disk (DVD), and semiconductor memories (e.g., a mask ROM, a programmable ROM (PROM), an erasable PROM (EPROM), a flash ROM, and a random-access memory (RAM)). The program may be supplied to the computer also by any of various types of transitory computer-readable media. Examples of the transitory computer-readable media include an electrical signal, an optical signal, and an electromagnetic wave. The transitory computer-readable media can supply the program to the computer via a wired communication path such as an electrical wire or an optical fiber, or a wireless communication path.

The present disclosure is not limited to the above-described example embodiments, and can be appropriately modified within a range that does not deviate from the essence. The present disclosure may be implemented with the respective example embodiments being appropriately combined with each other.

Although the present invention is described above with reference to the example embodiments (and examples), the present invention is not limited to the above-described example embodiments (and examples). Various modifications that can be understood by those skilled in the art can be made on the configuration and details of the present invention within the scope of the present invention.

A part or all of the above-described example embodiments can be described also as in the following Supplementary Notes, but are not limited thereto.

(Supplementary Note 1)

A seat guidance device including:

an authentication control means for causing an authentication device to perform face authentication on a first captured image of a specific visitor at a predetermined point in a predetermined facility, the authentication device storing registered face feature information of a plurality of visitors;

a reserved seat identification means for identifying a position of a reserved seat of the specific visitor based on reserved seat information in which each visitor and a position of a reserved seat of the visitor are associated with each other when the face authentication is successful;

a route identification means for identifying a movement route from the predetermined point to the identified position of the reserved seat based on seat information defining arrangement of a plurality of seats in the facility; and

an output means for outputting guidance information for guidance of the movement route.

(Supplementary Note 2)

The seat guidance device according to Supplementary Note 1, further including:

a storage means for storing the seat information and the reserved seat information; and

a visitor information update means for storing, as visitor information, the identified position of the reserved seat in the storage means when the face recognition is successful,

wherein the route identification means identifies the movement route further based on the visitor information.

(Supplementary Note 3)

The seat guidance device according to Supplementary Note 1 or 2, wherein the route identification means identifies the movement route for the specific visitor, in consideration of the movement route identified for a visitor who visits the facility before the specific visitor.

(Supplementary Note 4)

The seat guidance device according to any one of Supplementary Notes 1 to 3, wherein the route identification means analyzes a second captured image of an area near the identified movement route and thereby determines a congestion degree, and when the congestion degree is equal to or higher than a predetermined value, searches a detour route and identifies the searched detour route as the movement route.

(Supplementary Note 5)

The seat guidance device according to any one of Supplementary Notes 1 to 4, wherein the route identification means identifies a plurality of movement routes and assigns a priority level to each of the movement routes, and

the output means outputs the guidance information for guidance of the plurality of movement routes based on the priority level.

(Supplementary Note 6)

The seat guidance device according to any one of Supplementary Notes 1 to 5, further including:

an acquisition means for acquiring a third captured image of a seat group in the facility that is captured by a camera of a terminal of the specific visitor; and

a combined image output means for outputting a combined image in such a way as to be displayed on the terminal, the combined image being an image in which an indication image indicating the reserved seat is combined with the identified position of the reserved seat in the third captured image.

(Supplementary Note 7)

A seat guidance device including:

a storage means for storing registered face feature information of a plurality of visitors;

an authentication means for performing, by using the registered face feature information, face authentication on a first captured image of a specific visitor at a predetermined point in the facility;

a reserved seat identification means for identifying a position of a reserved seat of the specific visitor based on reserved seat information in which each visitor and a position of a reserved seat of the visitor are associated with each other when the face authentication is successful;

a route identification means for identifying a movement route from the predetermined point to the identified position of the reserved seat based on seat information defining arrangement of a plurality of seats in the facility; and

an output means for outputting guidance information for guidance of the movement route.

(Supplementary Note 8)

The seat guidance device according to Supplementary Note 7, wherein

the storage means stores the seat information and the reserved seat information,

the seat guidance device further comprises a visitor information update means for storing, as visitor information, the identified position of the reserved seat in the storage means when the face authentication is successful, and

the route identification means identifies the movement route further based on the visitor information.

(Supplementary Note 9)

A seat guidance system including:

a seat guidance device; and

an authentication device including a storage means configured to store registered face feature information of a plurality of visitors and an authentication means configured to perform face authentication using the registered face feature information, wherein

the seat guidance device is configured to:

cause the authentication device to perform face authentication on a first captured image of a specific visitor at a predetermined point in a predetermined facility;

identify a position of a reserved seat of the specific visitor based on reserved seat information in which each visitor and a position of a reserved seat of the visitor are associated with each other when the face authentication is successful;

identify a movement route from the predetermined point to the identified position of the reserved seat based on seat information defining arrangement of a plurality of seats in the facility; and

output guidance information for guidance of the movement route.

(Supplementary Note 10)

The seat guidance system according to Supplementary Note 9, wherein the seat guidance device is configured to: include a storage means configured to store the seat information and the reserved seat information; store, as visitor information, the identified position of the reserved seat in the storage means when the face authentication is successful; and identify the movement route further based on the visitor information.

(Supplementary Note 11)

A seat guidance method including, by a computer:

causing an authentication device to perform face authentication on a first captured image of a specific visitor at a predetermined point in a predetermined facility, the authentication device storing registered face feature information of a plurality of visitors;

identifying a position of a reserved seat of the specific visitor based on reserved seat information in which each visitor and a position of a reserved seat of the visitor are associated with each other when the face authentication is successful;

identifying a movement route from the predetermined point to the identified position of the reserved seat based on seat information defining arrangement of a plurality of seats in the facility; and

outputting guidance information for guidance of the movement route.

(Supplementary Note 12)

A seat guidance method including, by a computer storing registered face feature information of a plurality of visitors:

performing, by using the registered face feature information, face authentication on a first captured image of a specific visitor at a predetermined point in a predetermined facility;

identifying a position of a reserved seat of the specific visitor based on reserved seat information in which each visitor and a position of a reserved seat of the visitor are associated with each other when the face authentication is successful;

identifying a movement route from the predetermined point to the identified position of the reserved seat based on seat information defining arrangement of a plurality of seats in the facility; and

outputting guidance information for guidance of the movement route.

(Supplementary Note 13)

A non-transitory computer-readable medium storing a seat guidance program that causes a computer to execute:

processing of causing an authentication device to perform face authentication on a first captured image of a specific visitor at a predetermined point in a predetermined facility, the authentication device storing registered face feature information of a plurality of visitors;

processing of identifying a position of a reserved seat of the specific visitor based on reserved seat information in which each visitor and a position of a reserved seat of the visitor are associated with each other when the face authentication is successful;

processing of identifying a movement route from the predetermined point to the identified position of the reserved seat based on seat information defining arrangement of a plurality of seats in the facility; and

processing of outputting guidance information for guidance of the movement route.

(Supplementary Note 14)

A non-transitory computer-readable medium storing a seat guidance program that causes a computer storing registered face feature information of a plurality of visitors to execute:

processing of performing, by using the registered face feature information, face authentication on a first captured image of a specific visitor at a predetermined point in a predetermined facility;

processing of identifying a position of a reserved seat of the specific visitor based on reserved seat information in which each visitor and a position of a reserved seat of the visitor are associated with each other when the face authentication is successful;

processing of identifying a movement route from the predetermined point to the identified position of the reserved seat based on seat information defining arrangement of a plurality of seats in the facility; and

processing of outputting guidance information for guidance of the movement route.

### REFERENCE SIGNS LIST

100, 100a, 100b, 100c SEAT GUIDANCE DEVICE
110 STORAGE UNIT
102, 122 AUTHENTICATION CONTROL UNIT
102a AUTHENTICATION UNIT
103, 123 RESERVED SEAT IDENTIFICATION UNIT
104, 124 ROUTE IDENTIFICATION UNIT
105, 125 OUTPUT UNIT
106, 126 GENERATION UNIT
127 ACQUISITION UNIT
128 UPDATE UNIT
111 SEAT INFORMATION
112 RESERVED SEAT INFORMATION
113 SEAT GUIDANCE PROGRAM
114 VISITOR INFORMATION
130 MEMORY
140 COMMUNICATION UNIT
200 AUTHENTICATION DEVICE
210 FACE INFORMATION DB
220 FACE DETECTION UNIT
230 FEATURE POINT EXTRACTION UNIT
240 REGISTRATION UNIT
250 AUTHENTICATION UNIT
300, 300a, 300b, 300c FACE AUTHENTICATION TERMINAL
310 CAMERA
320 STORAGE UNIT
330 COMMUNICATION UNIT
340 DISPLAY UNIT
350 CONTROL UNIT
351 IMAGE CAPTURE CONTROL UNIT
352 DISPLAY CONTROL UNIT
400 USER TERMINAL
410 CAMERA
420 STORAGE UNIT
430 COMMUNICATION UNIT
440 DISPLAY UNIT
450 CONTROL UNIT
451 IMAGE CAPTURE CONTROL UNIT
452 DISPLAY CONTROL UNIT
453 REGISTRATION UNIT
500 NETWORK
600, 600a, 600b, 600c SEAT GUIDANCE SYSTEM

What is claimed is:

1. A seat guidance device comprising:
at least one memory storing instructions and at least one processor configured to execute the instructions to:
cause an authentication device to perform face authentication on a first captured image of a specific visitor at a predetermined point in a predetermined facility, the authentication device storing registered face feature information of a plurality of visitors;
identify a position of a reserved seat of the specific visitor based on reserved seat information in which each visitor and a position of a reserved seat of the visitor are associated with each other when the face authentication is successful;
identify a movement route from the predetermined point to the identified position of the reserved seat based on seat information defining arrangement of a plurality of seats in the facility; and
output means for outputting guidance information for guidance of the movement route.

2. The seat guidance device according to claim 1, wherein
the at least one memory is further configured to store
the seat information and the reserved seat information; and
the at least one processor is configured to execute the instructions to:
store, as visitor information, the identified position of the reserved seat in the at least one memory when the face recognition is successful, and
identify the movement route further based on the visitor information.

3. The seat guidance device according to claim 1, wherein the at least one processor is configured to execute the instructions to:
identify the movement route for the specific visitor, in consideration of the movement route identified for a visitor who visits the facility before the specific visitor.

4. The seat guidance device according to claim 1, wherein the at least one processor is configured to execute the instructions to:
analyze a second captured image of an area near the identified movement route and thereby determine a congestion degree and search a detour route and identify the searched detour route as the movement route when the congestion degree is equal to or higher than a predetermined value.

5. The seat guidance device according to claim 1, wherein
the at least one processor is configured to execute the instructions to:
identify a plurality of movement routes and assign a priority level to each of the movement routes, and
output the guidance information for guidance of the plurality of movement routes based on the priority level.

6. The seat guidance device according to claim 1, wherein
the at least one processor is configured to execute the instructions to:
acquire a third captured image of a seat group in the facility that is captured by a camera of a terminal of the specific visitor; and
output a combined image in such a way as to be displayed on the terminal, the combined image being an image in which an indication image indicating the reserved seat is combined with the identified position of the reserved seat in the third captured image.

7. A seat guidance device comprising:
at least one memory storing instructions and
registered face feature information of a plurality of visitors; and
at least one processor configured to execute the instructions to:
perform, by using the registered face feature information, face authentication on a first captured image of a specific visitor at a predetermined point in a predetermined facility;
identify a position of a reserved seat of the specific visitor based on reserved seat information in which each visitor and a position of a reserved seat of the visitor are associated with each other when the face authentication is successful;
identify a movement route from the predetermined point to the identified position of the reserved seat based on seat information defining arrangement of a plurality of seats in the facility; and
output guidance information for guidance of the movement route.

8. The seat guidance device according to claim 7, wherein
the at least one memory is further configured to store
the seat information and the reserved seat information, and
the at least one processor is further configured to execute the instructions to:
store, as visitor information, the identified position of the reserved seat in the at least one memory when the face authentication is successful, and
identify the movement route further based on the visitor information.

9. A seat guidance system comprising:
a seat guidance device; and
an authentication device including storage means configured to store registered face feature information of a plurality of visitors and authentication means configured to perform face authentication using the registered face feature information, wherein
the seat guidance device is configured to:
cause the authentication device to perform face authentication on a first captured image of a specific visitor at a predetermined point in a predetermined facility;
identify a position of a reserved seat of the specific visitor based on reserved seat information in which each visitor and a position of a reserved seat of the visitor are associated with each other when the face authentication is successful;
identify a movement route from the predetermined point to the identified position of the reserved seat based on seat information defining arrangement of a plurality of seats in the facility; and
output guidance information for guidance of the movement route.

10. The seat guidance system according to claim 9, wherein the seat guidance device is configured to: further include storage means configured to store the seat information and the reserved seat information; store, as visitor information, the identified position of the reserved seat in the storage means when the face authentication is successful; and identify the movement route further based on the visitor information.

11. A seat guidance method comprising, by a computer:
causing an authentication device to perform face authentication on a first captured image of a specific visitor at a predetermined point in a predetermined facility, the authentication device storing registered face feature information of a plurality of visitors;
identifying a position of a reserved seat of the specific visitor based on reserved seat information in which each visitor and a position of a reserved seat of the visitor are associated with each other when the face authentication is successful;
identifying a movement route from the predetermined point to the identified position of the reserved seat based on seat information defining arrangement of a plurality of seats in the facility; and
outputting guidance information for guidance of the movement route.

12. A seat guidance method comprising, by a computer storing registered face feature information of a plurality of visitors:
performing, by using the registered face feature information, face authentication on a first captured image of a specific visitor at a predetermined point in a predetermined facility;
identifying a position of a reserved seat of the specific visitor based on reserved seat information in which each visitor and a position of a reserved seat of the visitor are associated with each other when the face authentication is successful;
identifying a movement route from the predetermined point to the identified position of the reserved seat based on seat information defining arrangement of a plurality of seats in the facility; and
outputting guidance information for guidance of the movement route.

13. A non-transitory computer-readable medium storing a seat guidance program that causes a computer to execute:
processing of causing an authentication device to perform face authentication on a first captured image of a specific visitor at a predetermined point in a predetermined facility, the authentication device storing registered face feature information of a plurality of visitors;
processing of identifying a position of a reserved seat of the specific visitor based on reserved seat information in which each visitor and a position of a reserved seat of the user are associated with each other when the face authentication is successful;
processing of identifying a movement route from the predetermined point to the identified position of the reserved seat based on seat information defining arrangement of a plurality of seats in the facility; and
processing of outputting guidance information for guidance of the movement route.

14. A non-transitory computer-readable medium storing a seat guidance program that causes a computer storing registered face feature information of a plurality of visitors to execute:
processing of performing, by using the registered face feature information, face authentication on a first captured image of a specific visitor at a predetermined point in a predetermined facility;
processing of identifying a position of a reserved seat of the specific visitor based on reserved seat information in which each visitor and a position of a reserved seat of the visitor are associated with each other when the face authentication is successful;
processing of identifying a movement route from the predetermined point to the identified position of the reserved seat based on seat information defining arrangement of a plurality of seats in the facility; and
processing of outputting guidance information for guidance of the movement route.
